(19) United States
(12) Patent Application Publication
(10) Pub. No.: US 2025/0229202 A1
(43) Pub. Date: Jul. 17, 2025

(54) MULTI-LAYER POROUS POLYMERIC MEMBRANE AND RELATED FILTERS AND METHODS

(71) Applicant: ENTEGRIS, INC., Billerica, MA (US)

(72) Inventors: Yasushi Ohyashiki, Narashino-shi (JP); Vinay Kalyani, Salem, NH (US); Christi A. Dawydiak, Medford, MA (US)

(21) Appl. No.: 19/017,266

(22) Filed: Jan. 10, 2025

Related U.S. Application Data
(60) Provisional application No. 63/620,072, filed on Jan. 11, 2024.

(51) Int. Cl. B01D 37/04; B01D 27/14; B01D 29/00; B01D 29/05; B01D 39/16

(52) U.S. Cl. CPC B01D 37/04; B01D 27/146; B01D 29/0093; B01D 29/05; B01D 39/1692; B01D 2201/04; B01D 2221/14

(57) ABSTRACT

Described are assemblies of porous polymeric filter membranes that include two polymeric filter membranes in series, i.e., as part of a membrane assembly; filter components and filter products that include the two polymeric filter membrane layers; methods of assembling the polymeric filter membranes, filter components, and filter products; and methods of using the polymeric filter membranes to remove particles from a liquid such as a semiconductor processing liquid fluid.

### CROSS-REFERENCE TO RELATED APPLICATION

This application claims the benefit of and priority to U.S. Provisional Application No. 63/620,072 filed on Jan. 11, 2024, which is incorporated herein by reference in its entirety for all purposes.

### FIELD

The following description relates to assemblies that include two polymeric filter membranes in series, i.e., as part of a membrane assembly; also to filter components and filter products that include the two polymeric filter membranes; also to methods of assembling the polymeric filter membranes, filter components, and filter products; and to methods of using the polymeric filter membranes to remove particles from a liquid such as a semiconductor processing fluid.

### BACKGROUND

Polymeric filter membranes are used for removing unwanted materials from fluids having a range of applications. The fluids include water, liquid industrial solvents and processing fluids, industrial gases used for manufacturing or processing, and liquids that have medical or pharmaceutical uses. Contaminants and impurities that are removed from a fluid include particle contaminants, microorganisms, and dissolved chemical species such as ionic species.

Two or more types of filter membranes may be used together to remove different types of contaminants or impurities from a single liquid. Certain types of filter membranes remove contaminants from a liquid via a sieving mechanism by which contaminant particles that are larger than a pore of a membrane are mechanically prevented from passing through the membrane and become trapped within the membrane to not pass through the membrane. Other membranes function via a non-sieving mechanism by which impurities that are smaller than the pores of a membrane are attracted to the membrane surface via a chemical or electrostatic interaction and are held within the membrane and do not escape the membrane. By combining a non-sieving membrane with a sieving membrane, both larger and smaller contaminants may be removed from a liquid that contains particles of different sizes.

Using filters to remove contaminants from liquids is particularly important in the semiconductor processing industry where even the smallest impurities, sometimes of a nanoscale size range, can produce a defect within a microelectronic device. This is true for many fluids used during semiconductor and microelectronics processing, one example being a photoresist solution used in photolithography.

In photolithographic processing a light-sensitive (or radiation-sensitive) photoresist solution is used to form a patterned coating on a surface. The photoresist solution is coated as a thin layer onto a substrate surface and a patterned mask is used to cover a portion of the coated surface. The unmasked areas of the photoresist solution are exposed to light. A solvent, called a developer, is then applied to the surface of the photoresist solution. For a “positive photoresist,” the portion of the photoresist that is exposed to the light is degraded by the light and the developer dissolves away areas of the photoresist coating that were exposed to light, leaving behind a patterned coating where the mask was placed. For a “negative photoresist,” the portion of the photoresist that is exposed to the light is strengthened (either polymerized or cross-linked) by the light, and the developer will dissolve away only the masked areas of photoresist that were not exposed to light and leave behind a patterned coating at areas not covered by the mask.

Conventional photoresist solutions can include three different components: a polymeric resin (a binder that provides physical properties such as adhesion, chemical resistance, etc.), sensitizer (which has a photoactive compound), and solvent. Unfortunately, a photoresist solution will also contain an amount of unwanted contaminant particles that can become located at a surface of a semiconductor substrate where the contaminant may produce a defect during subsequent processing. The contaminants may be particles or suspended or dissolved chemical species and can have a range of sizes, including particles of a nanometer-scale size.

The semiconductor manufacturing industry is in continuing need of ever-improving filtering technologies, including to effectively remove high percentages of contaminants of different types and sizes from liquids such as photoresist solutions.

### SUMMARY

The following describes filter assemblies, products, and methods that use a first polymeric filter membrane referred to as an “open” membrane and a second polymeric filter membrane referred to as a “tight” membrane. The first (open) polymeric filter membrane has relatively larger pores on average and a lower bubble point, compared to the second polymeric filter membrane having relatively smaller pores and a higher bubble point. The first or “open” polymeric filter membrane also has a relatively larger thickness compared to a smaller thickness of the second or “tight” polymeric filter membrane.

The polymeric filter membranes are useful for removing contaminants from a flow of a liquid through the membranes, for example by passing the liquid first through the first (open) polymeric filter membrane and subsequently through the second (tight) polymeric filter membrane.

According to example methods and membranes, and without limiting the present description, the first (open) polymeric filter membrane can be a polyolefin membrane prepared by a phase inversion technique, and the second (tight) polymeric filter membrane can be a polyolefin membrane prepared by a stretching technique. In general, phase inversion polyolefin filter membranes have a greater thickness and more complicated microporous structure than stretched polyolefin filter membranes, and the phase inversion polyolefin filter membrane can exhibit retention capabilities for a wider range of differently-sized particles and more retention capacity.

It is difficult to make polymeric filter membranes with smaller pore sizes without also causing a significant loss of flow rate of the membrane. Stretched polyolefin filter membranes can be very thin, such as having a thickness of less than 10 microns while also having relatively small pore size and may achieve a useful combination of both very tight (small) pore size and good flow rate. However, thinner stretch membranes have less retention capacity because of a limited effective surface area and less space within the thinner membrane.

According to examples described herein a first (open) polymeric filter membrane that may be prepared by a phase inversion method, and a second (tight) polymeric filter membrane that may be prepared by a stretching method, can be used together in series to remove contaminants from a liquid. The open polymeric filter membrane can remove relatively larger-sized contaminants from a liquid that contains contaminants of both larger and smaller sizes. The tight polymeric filter membrane can remove relatively smaller-sized particles or dissolved contaminants that may pass through the first (upstream) polymeric filter membrane. The combination of two polymeric filter membranes is effective to remove different types and sizes of contaminants from a liquid that passes through both the first polymeric filter membrane and the second polymeric filter membrane, including particulate contaminants that may be a relatively larger size and dissolved or suspended chemical molecules that may be a relatively smaller in size.

In one aspect, the description relates to a method of filtering a semiconductor processing liquid. The method includes: passing the liquid through a first polymeric filter membrane having: a mean bubble point below 120 pounds per square inch measured using ethoxy-nonafluorobutane (HFE7200), and a thickness of at least 20 microns; and passing the liquid through a second polymeric filter membrane having: a mean bubble point greater than 120 pounds per square inch measured using ethoxy-nonafluorobutane (HFE7200), and a thickness less than 20 microns.

According to another aspect, the description relates to a filter product useful to remove a contaminant from a semiconductor processing fluid. The filter product includes: a first polymeric filter membrane having: a mean bubble point below 120 pounds per square inch measured using ethoxy-nonafluorobutane (HFE7200) and a thickness of at least 20 microns; and a second polymeric filter membrane having a mean bubble point greater than 120 pounds per square inch measured using ethoxy-nonafluorobutane (HFE7200) and a thickness less than 20 microns.

### BRIEF DESCRIPTION OF THE DRAWINGS

FIG. 1 shows an example of an assembly that includes a first (open) polymeric filter membrane and a second (tight) polymeric filter membrane in series.

FIG. 2 shows an example of a filter product that includes a first (open) polymeric filter membrane and a second (tight) polymeric filter membrane.

FIG. 3 shows an example of a filter product that includes a first (open) polymeric filter membrane and a second (tight) polymeric filter membrane included in a filter housing.

FIGS. 4 and 5 show retention data of polymeric filter membrane assemblies as described, and of comparative polymeric filter membranes.

Figures are schematic and not necessarily to scale.

### DETAILED DESCRIPTION

The following describes polymeric filter membranes (or more simply “membranes,” “filter membranes,” or the like, as used herein); assemblies that contain two or more polymeric filter membranes including a “first” (or “open”) polymeric filter membrane and a “second” (or “tight”) polymeric filter membrane; filter products that contain the first and second polymeric filter membranes; and related methods of using the polymeric filter membrane assemblies and filter products, particularly for removing contaminants from semiconductor processing liquids. Herein, a first polymeric filter membrane is sometimes referred to as a “first membrane” or as an “open membrane,” and a second polymeric filter membrane is sometimes used to refer to a “second membrane” or as a “tight membrane.”

Filter products and filtration methods as described use an arrangement of two different polymeric filter membranes, i.e., at least two different “membranes” or “membrane layers” arranged in series to perform a filtering step. The arrangement may sometimes be referred to as a “stacked” arrangement or as a “multi-layer membrane assembly” that includes the two different polymeric filter membranes and may optionally include additional filtration membranes or support layers. The polymeric filter membranes may be assembled as a laminated composite membrane wherein the first and second polymeric filter membranes are bonded together by lamination (without using a separate adhesive), or the polymeric filter membranes may be un-attached, i.e., non-laminated.

The first polymeric filter membrane or “open membrane” is adapted to remove relatively larger-sized contaminants from a liquid that contains contaminants having a range of larger and smaller sizes. The open membrane has pores of a relatively larger pore size compared to smaller pores of a tight membrane. The tight membrane may have pores of relatively smaller size and a smaller thickness compared to a larger thickness of the open membrane. The combination of two polymeric filter membranes is effective to remove different types of particles from a liquid that passes through both the first polymeric filter membrane and the second polymeric filter membrane, including particulate contaminants that may be relatively larger in size, and dissolved or suspended chemical molecules that may be relatively smaller in size. The tight membrane is adapted to remove and sequester relatively smaller-sized particles or dissolved contaminants that may pass through the open membrane.

According to example methods and filter assemblies, a liquid can be caused to flow first through the open membrane that has the larger thickness and larger pores, and second through the tight membrane that has the smaller thickness and smaller pores. An assembly that includes a combination of an open upstream polymeric filter membrane and a tight downstream polymeric filter membrane can be useful to remove contaminants over a range of different sizes from a liquid. Desirably, an assembly that includes both an open membrane and a tight membrane can be effective to remove a greater amount (a higher percentage) of contaminants (e.g., of a particular size) from a liquid compared to: an amount of contaminants removed by filtering the liquid using the tight membrane alone; and also an amount of contaminants removed by filtering the liquid using the open membrane alone. Performance of polymeric filter membranes to remove contaminants of a particular size from a liquid can be measured in terms of “retention” and can be assessed by a retention test that removes standard particles (or “test particles”) from a sample liquid having a known concentration of the particles, under controlled conditions.

According to certain particular membrane assemblies and methods, a membrane assembly that includes at least one open membrane and at least one tight membrane can be used to remove contaminants of various sizes from a liquid that contains the contaminants. The liquid may be any type of liquid that is significantly pure but contains contaminants having a range of sizes that are desirably by filtration. Examples of such liquids include various types of liquids that are used in semiconductor or microelectronic device processing, these types of liquids being referred to herein as “semiconductor processing fluids.” Semiconductor processing fluids include liquids that are used as or that contain one or more of: water or organic solvent such as isopropyl alcohol (among many other organic and inorganic chemicals that include organic solvents and organic or inorganic acids and bases, see below); reactive material such as reactive monomer, oligomer, or polymer, including but not limited to types used in photosensitive materials such as photoresist solutions; cleaning solutions; acids or bases; among others. A specific example of a semiconductor processing fluid is a “photoresist solution” that includes a polymeric resin, sensitizer (which has a photoactive compound), and solvent.

Each of the open polymeric membrane and the tight polymeric membrane has two opposed surfaces or opposed “sides” and a membrane thickness between the two opposed surfaces. Pores of a polymeric filter membrane are located across the thickness of the membrane to allow for a flow of a liquid from one side of the membrane, through the thickness of the membrane, to and through the opposite side of the membrane. This type of membrane is sometimes referred to as an “open pore” membrane.

Open pore membranes can be in the form of a thin film or sheet of porous polymeric material having a relatively uniform thickness and an open pore structure that includes a polymeric matrix that defines a large number of open “cells” or “pores.” The open cells can be referred to as openings, pores, channels, or passageways that are largely interconnected between adjacent cells to allow fluid to flow through the thickness of the membrane from one side of the membrane to the other side. The passages may provide tortuous tunnels or paths through which a liquid being filtered must pass. Contaminants in the form of particles or dissolved or suspended molecular chemical species that are contained in a liquid that passes through the polymeric filer membrane become trapped by or within the membrane either based on size (i.e., a “sieving” mechanism) or based on chemical or electrostatic attraction between the membrane surface and the contaminant (i.e., a “non-sieving” mechanism).

A polymeric filter membrane may be made from one or a combination of polymeric materials known to be useful to make open pore membranes, and can be described in terms of physical properties such as thickness, morphology, pore size, porosity, etc. Examples of useful polymer materials include polyolefins such as polyethylene (PE) (which includes polyethylene of various molecular weights such as ultrahigh molecular weight polyethylene (UPE), and which includes homopolymers, copolymers and blends) and polypropylene (PP) (also including copolymers and blends thereof). Other polymers that may be used to form a polymeric filter membrane include polyethers such as polyether ether ketone (PEEK), polysulfone, polyamides (e.g., nylon), fluoropolymers (including fluorinated and perfluorinated polymers), polyesters (e.g., polyethylene terephthalate), as well as other types of polymers and copolymers known to be useful for preparing polymeric filter membranes.

The term “polyethylene” refers to a polymer that has, in part or substantially, a linear molecular structure of repeating —CH₂—CH₂— units. Polyethylene can be made by reacting monomer composition that includes monomers comprising, consisting of, or consisting essentially of ethylene monomers. Thus, a polyethylene polymer may be a polyethylene homopolymer prepared by reacting monomers that consist of or consist essentially of ethylene monomers. Alternatively, a polyethylene polymer may be a polyethylene copolymer prepared by reacting a combination of ethylene and non-ethylene monomers that includes, consists of, or consists essentially of ethylene monomers and one or more additional types of monomer such as another alpha-olefin monomer, e.g., an alkene such as butene, hexene, or octene, or a combination of these. For a polyethylene copolymer, the amount of ethylene monomer used to produce the copolymer relative to non-ethylene monomers can be any useful amount, such as an amount of at least 50, 60, 70, 80, or 90 percent (by weight) ethylene monomer per total weight of all monomers (ethylene monomer and non-ethylene monomer) in a monomer composition used to prepare the ethylene copolymer.

The term “polypropylene” refers to a polymer that has, in part or substantially, a molecular structure of repeating —CH—CH(CH₃)— units. Polypropylene can be made by reacting monomer composition that includes monomers comprising, consisting of, or consisting essentially of propylene monomers. Thus, a polypropylene polymer may be a polypropylene homopolymer prepared by reacting monomers that consist of or consist essentially of propylene monomers. Alternatively, a polypropylene polymer may be a polypropylene copolymer prepared by reacting a combination of propylene and non-propylene monomers that includes, consists of, or consists essentially of propylene monomers and one or more additional types of monomer such as another alpha-olefin monomer, e.g., an alkene such as ethylene, butene, hexene, or octane, or a combination of these. For a polypropylene copolymer, the amount of propylene monomer used to produce the copolymer relative to non-propylene monomers can be any useful amount, such as an amount of at least 50, 60, 70, 80, or 90 percent (by weight) propylene monomer per total weight of all monomers (propylene monomer and non-propylene monomer) in a monomer composition used to prepare the propylene copolymer.

As used herein, a composition (e.g., polymer composition) that is described as “consisting essentially of” a certain ingredient or a combination of specified ingredients is a composition that contains the ingredient or combination of specified ingredients and not more than a small or insignificant amount of other materials, e.g., not more than 3, 2, 1, 0.5, 0.1, or 0.05 weight percent of any other ingredient or combination of ingredients.

For example, polymer that is prepared from monomers that “consist essentially of” olefin, ethylene, or propylene monomers is a polymer that is prepared from olefin monomers, ethylene monomers, or propylene monomers, respectively, and not more than a small or insignificant amount of other monomeric materials, e.g., not more than 3, 2, 1, 0.5, 0.1, or 0.05 weight percent of any other monomers.

As another example, a polymer composition or a polymeric membrane that is described as “consisting essentially of” polyolefin, polyethylene, or polypropylene is a polymer composition or a polymeric membrane that contains polyolefin (including copolymers), polyethylene (including copolymers), or polypropylene (including copolymers), respectively, and not more than a small or insignificant amount of a different type of polymer, e.g., not more than 3, 2, 1, 0.5, 0.1, or 0.05 weight percent of any other type of polymer.

Example assemblies of polymeric filter membranes can include two polymeric filter membranes arranged in series to allow liquid to flow first through a first (upstream) polymeric filter membrane that is an open membrane as described, then through a second (downstream) polymeric filter membrane that is a tight membrane as described. The first (open) polymeric filter membrane is relatively thicker compared to the second (tight) polymeric filter membrane and has pores of relatively larger sizes compared to the second polymeric filter membrane.

A first (open) polymeric filter membrane may be made of any useful polymer such as a polyolefin (e.g., polypropylene, polyethylene, or copolymers thereof), polyether ether ketone (PEEK), polysulfone, polyamide (e.g., nylon), fluoropolymer (including fluorinated and perfluorinated polymers), polyester (e.g., polyethylene terephthalate), as well as other types of polymers and copolymers that can be formed into an open polymeric filtration membrane. According to example membrane assemblies, a first polymeric filter membrane may have a relatively greater thickness compared to the second membrane, relatively larger pore size (average) compared to the second polymeric filter membrane, a relatively higher measured “flow time” compared to the second polymeric filter membrane, and a lower bubble point compared to the second polymeric filter membrane.

The first polymeric filter membrane can be an open pour membrane of a type that is useful as a polymeric filter membrane, for example a polymeric filter membrane useful to remove contaminants from a semiconductor processing liquid. A first polymeric filter membrane has physical properties (e.g., pore size, porosity, and bubble point) and filtration properties (e.g., retention and flow time or flow rate) that allow the first polymeric filter membrane to be useful either alone as a polymeric filtration membrane to remove undesired contaminants from a flow of liquid, or as part of a filter membrane assembly in combination with a second (tight) polymeric filter membrane.

A useful first polymeric filter membrane may be of a type sometimes described as an ultraporous membrane, a nanoporous membrane, a microporous membrane, etc. These polymeric filter membranes are generally effective to remove undesired contaminants (e.g., particle materials or dissolved chemical species or both) from a flow of liquid. A useful average pore size can be selected based on one or more factors that include: fluid flow rate, pressure, pressure drop considerations, viscosity considerations, the amounts and types of contaminants in a liquid to be filtered (e.g., dissolved metal ions or particle contaminants in a liquid). Examples of useful first polymeric filter membranes include various membrane that are commercially available and known to be useful in microfiltration applications, including polymeric filter membranes that are considered to be microporous, ultraporous, or nanoporous. Example first polymeric filter membranes can have an average pore size in a range of from about 0.001 microns to about 5 or 10 microns (1 nanometer to about 5,000 or 10,000 nanometers (nm)), e.g., from 0.01 to 0.8 microns (from 10 nanometers to 800 nanometers).

Useful or preferred first polymeric filter membranes may be considered to have relatively uniform pore sizes and a degree of pore symmetry, or may have relatively non-uniform pore sizes and a degree of pore asymmetry. A polymeric filter membrane may be isotropic or anisotropic with respect to pore size, symmetric or asymmetric, “skinned” or “un-skinned,” or a combination of these. A polymeric filter membrane that has pores of substantially uniform size uniformly distributed throughout the membrane thickness is often referred to as “isotropic” or “homogeneous.” In comparison, an anisotropic (a.k.a., “asymmetric”) membrane may be considered to have a morphology in which a pore size gradient exists across the membrane. For example, an anisotropic or asymmetric membrane may have a porous structure with relatively larger pores at one membrane surface and relatively smaller pores at the other membrane surface with the pore structure varying along the thickness of the membrane. The term “asymmetric” is often used interchangeably with the term “anisotropic.”

The first polymeric filter membrane may be in the form of a sheet having a relatively uniform thickness, such as a thickness in a range from 20 to 300 microns, e.g., from 30 or 50 to 150, 200, or 250 microns.

A first polymeric filter membrane may have any porosity that will allow the polymeric filter membrane to be effective as described herein. Example first polymeric filter membranes can have a relatively high porosity, for example a porosity in a range from 40 to 80 percent. As used herein, a “porosity” of a polymeric filter membrane (also sometimes referred to as void fraction) is a measure of the void (i.e., “empty”) space in the polymeric filter membrane as a percent of the total volume of the polymeric filter membrane and is calculated as a fraction of the volume of voids of the polymeric filter membrane over the total volume of the polymeric filter membrane. A body that has zero percent porosity is completely solid.

Examples of polymeric filter membranes that may be useful as the first polymeric filter membrane and that have physical properties as described include polyolefin (e.g., polyethylene and polypropylene) membranes that are prepared by known methods that include melt casting and phase inversion methods, with specific examples including thermally-induced phase separation methods (TIPS), solvent evaporation-induced phase separation (SEIPS), and nonsolvent-induced phase separation.

A first polymeric filter membrane may be treated or coated to improve the removal of dissolved or suspended contaminants in a liquid by a non-sieving filtering mechanism by adding ionic groups, either cationic groups or anionic groups, to surface of the polymeric filter membrane.

Bubble point is an understood property of polymeric filter membranes and relates to pore size of the polymeric filter membrane. A relatively higher bubble point indicates relatively smaller pores of a polymeric filter membrane and a relatively lower bubble point indicates relatively larger pore size of a polymeric filter membrane. A bubble point measurement is based on the premise that for a particular fluid and pore size with constant wetting of a polymeric filter membrane, the pressure needed to force an air bubble through pores of a polymeric filter membrane is in inverse proportion to the size of the pore. A Porosimetry Bubble Point test method measures the pressure required to push a gas (e.g., air) through wet pores of a membrane. A bubble point test is a well-known method for determining or estimating pore size of a membrane. Examples of useful mean bubble points of a first polymeric filter membrane as described, measured using the test method described herein (using ethoxy-nonafluorobutane (HFE-7200) as a wetting solvent and a temperature of 22° C.), can be less than 130 psi, e.g., in a range from 50 or 60 up to 110 or 120 psi.

In combination with a desired bubble point and filtering performance (e.g., measured by retention, described herein), a first polymeric filter membrane can exhibit a useful flow rate of liquid through the polymeric filter membrane. A rate of flow of liquid through a polymeric filter membrane can be measured in terms of flow rate or flow time (which is an inverse to flow rate). A first polymeric filter membrane as described can have a useful or a relatively low flow time, preferably in combination with a bubble point in a range as described and good filtering performance (e.g., as measured by a retention test). Useful examples of first (open) polymeric filter membranes may have a measured flow time that is below about 15,000 seconds or under 13,000 seconds measured using isopropyl alcohol (IPA) as described herein, e.g., under 10,000, 5,000, or 1,000 seconds.

A level of effectiveness of a polymeric filter membrane to remove contaminants (including dissolved or suspended chemical molecules) from a liquid can be measured, in one fashion, as “retention.” Retention with reference to filtering performance of a polymeric filter membrane generally refers to a total amount of one or more contaminants removed from a liquid (with the filter in use, or under test conditions) that contains the contaminants, relative to the total amount of the one or more contaminants present in the liquid before passing the liquid through the polymeric filter membrane. The “retention” value of a polymeric filter membrane is thus a percentage, with a polymeric filter membrane that has a higher retention value (a higher percentage) being relatively more effective in removing a contaminant from a liquid, and a polymeric filter membrane that has a relatively lower retention value (a lower percentage) being less effective in removing a contaminant from a liquid.

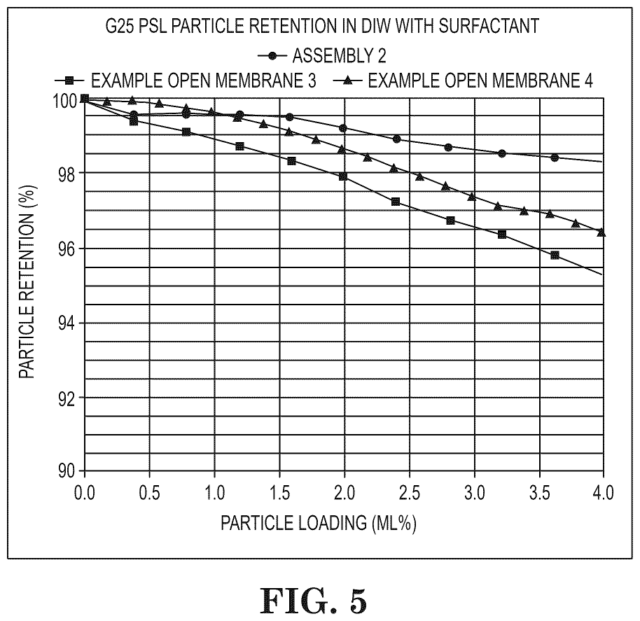

As measured under test conditions, examples of first (open) polymeric filter membranes can exhibit a retention that exceeds 98 or 99 percent for a monolayer coverage of 1.0 percent; a retention that exceeds 97 or 98 percent for a monolayer coverage of 2.0; a retention that exceeds 98 or 99 percent for a monolayer coverage of 2.0; a retention that exceeds 95, 96, or 97 percent for a monolayer coverage of 3.0; and a retention that exceeds 94 or 95 percent for a monolayer coverage of 4.0; each as measured using the test method described herein. See FIG. 5.

The second polymeric filter membrane is thinner compared to the first polymeric filter membrane and has pores of smaller size compared to the first polymeric filter membrane. The second polymeric filter membrane may be made of any useful polymer and may preferably be prepared from a polyolefin such as polypropylene, polyethylene, including copolymers thereof, or a blend of two or more polyolefins or polyolefin copolymers. Certain examples of second polymeric filter membranes may comprise, consist of, or consist essentially of polymer that is polyolefin such as polypropylene, polyethylene, or a blend of polyethylene and polypropylene.

A second polymeric filter membrane of an assembly may either consist of a single polymeric filter membrane or may alternately include two or more “sublayers,” in which case the second polymeric filter membrane may be considered a “multi-layer” membrane that includes the two or more sublayers. The second polymeric filter membrane may be in the form of a sheet having a relatively uniform thickness. A second polymeric filter membrane of an assembly that consists of a single filtering layer (a single polymeric filter membrane) may have a thickness that is less than 10, 15, or 20 microns, e.g., may have a thickness in a range from 0.1 to 10 microns, or from 0.2 to 5 microns. A second polymeric filter membrane that includes two or more sublayers may include sublayers that each have a thickness within these ranges, and may have a total thickness within these ranges.

The second “tight” polymeric filter membrane has pores that are smaller than the pores of the first “open” polymeric filter membrane, and that will allow the second polymeric filter membrane to be effective for performing as a tight layer of a filter assembly as described, e.g., to remove relatively small contaminants from a liquid that have not been removed by the liquid flowing through a first “open” polymeric filter membrane upstream from the second “tight” polymeric filter membrane. In some example second polymeric filter membranes, or example sublayers of a second membrane, a second polymeric filter membrane or a sublayer thereof can have an average pore size in a range of from about 0.001 microns to about 0.1 micron (1 nanometer to about 500 (nm)), e.g., from 0.01 to 0.05 microns (from 10 to 50 nanometers), or from 0.001 to 0.005 microns (from 1 to 5 nanometers).

Examples of polymeric filter membranes that may be useful as the second polymeric filter membrane and that have physical properties as described may be prepared by known methods of preparing a polyolefin membrane by any useful technique (e.g., an extrusion, melt casting, or phase inversion technique) followed by uni-axially or bi-axially stretching the membrane to a reduced thickness. By one technique, a second polymeric filter membrane that contains (comprises, consists essentially of, or consists of) polyethylene (including copolymers), polypropylene (including copolymers), or a blend thereof may be prepared by extruding a polymeric (polyolefin) resin that contains a diluent to form a polyolefin sheet, and stretching the sheet followed by steps of extracting and annealing.

A second polymeric filter membrane may be treated or coated to improve the removal of dissolved or suspended contaminants in a liquid by a non-sieving filtering mechanism by adding ionic groups, either cationic groups or anionic groups, to surface of the membrane.

A useful or preferred second polymeric filter membrane, whether in the form of a single layer or multiple sub-layers, can have physical properties (e.g., pore size, porosity, and bubble point) and filtration properties (e.g., retention and flow time or flow rate) that are effective to allow the second polymeric filter membrane to be useful alone as a polymeric filtration membrane to remove undesired contaminants from a flow of liquid, or as one polymeric filter membrane in combination with another polymeric filter membrane as part of an assembly of two or more polymeric filter membranes as described, that includes a first (open) polymeric filter membrane in combination with a second (tight) polymeric filter membrane.

A bubble point of a second (tight) polymeric filter membrane of an assembly that includes (comprises, consists essentially of, or consists of) a first (open) polymeric filter membrane and a second (tight) polymeric filter membrane may preferably by greater than a bubble point of the first (open) polymeric filter membrane. Examples of useful bubble points of a second (tight) polymeric filter membrane as described, measured using the test method described in the Examples section herein, can be greater than 100 psi, e.g., in a range from 120 to 300 psi, e.g., in a range from 130 to 200 psi.

A second polymeric filter membrane may have any porosity that will allow the polymeric filter membrane to be effective when used as a second polymeric filter membrane as described herein. Example second polymeric filter membranes can have a relatively high porosity, for example a porosity in a range from 40 to 80 percent.

A second polymeric filter membrane can have a useful or a relatively low flow time, preferably in combination with a bubble point that is relatively high and good filtering performance when measured alone. A second polymeric filter membrane may have a flow time that is less than a flow time of a first polymeric filter membrane that is used with the second polymeric filter membrane. An example second polymeric filter membrane may have a measured flow time that is below about 15,000 seconds or under 11,000 seconds or under 10,000, 9,000, or 5,000, or 1,000 seconds measured using IPA as described infra.

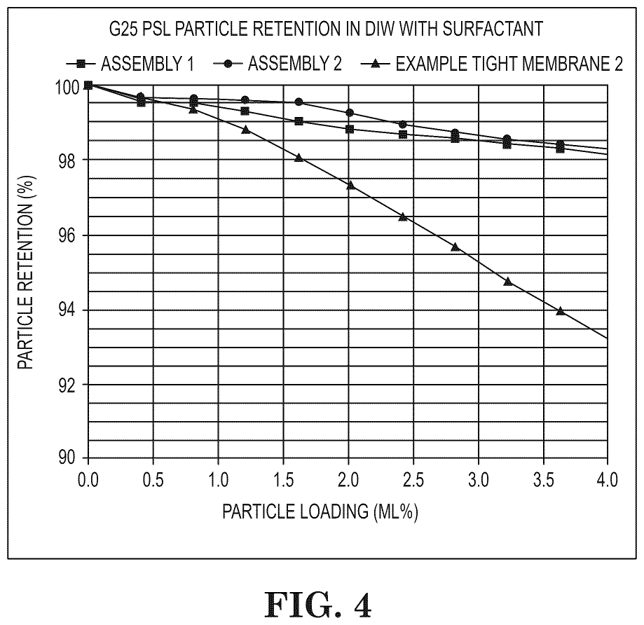

Example second polymeric filter membranes can exhibit a retention that exceeds 97 or 98 percent for a monolayer coverage of 1.0 percent; a retention that exceeds 95 or 96 percent for a monolayer coverage of 2.0; a retention that exceeds 96 or 97 percent for a monolayer coverage of 2.0; a retention that exceeds 93 or 94 percent for a monolayer coverage of 3.0; and a retention that exceeds 91 or 92 percent for a monolayer coverage of 4.0; each as measured using the test described in the Examples section, with a useful flow rate through the membrane. See FIG. 4.

A membrane assembly that includes the first polymeric filter membrane and the second polymeric filter membrane in series may have a total thickness of the two polymeric filter membranes that equals the combined thicknesses of the first polymeric filter membrane and the second polymeric filter membrane, not including any additional polymeric filter membranes, filtering elements, or support layers that may be used in combination with the first and second polymeric filter membranes of an assembly. Example thickness values of a membrane assembly may be comparable to a thickness of a first polymeric filter membrane of the assembly, e.g., in a range from 20 to 300 microns, e.g., from 30 or 50 to 150, 200, or 250 microns.

A membrane assembly, like each of a first polymeric filter membrane and a second polymeric membrane that make up the assembly, can also be assessed in terms of properties of the assembly such as bubble point, retention, and flow time.

A bubble point of an assembly that includes (comprises, consists essentially of, or consists of) the first polymeric filter membrane and the second polymeric filter membrane may preferably by greater than the bubble point of the first (open) polymeric filter membrane. According to example membrane assemblies, an assembly may have a bubble point (mean bubble point) that is comparable to a bubble point of a second (tight) polymeric filter membrane of the assembly, e.g., a mean bubble point measured as pounds per square inch that is within 10 percent of the mean bubble point of the second (tight) membrane. Example mean bubble points of a membrane assembly may be greater than 100 psi, e.g., in a range from 120 to 300 psi, e.g., in a range from 130 to 200 psi.

Retention of an assembly that includes (comprises, consists essentially of, or consists of) a first (open) polymeric filter membrane and second (tight) polymeric filter membrane may be better compared to both of: a retention of the first (open) polymeric filter membrane, and a retention of the second (tight) polymeric filter membrane, when the retention of each of the first polymeric filter membrane and the second polymeric filter membrane is measured individually. This may be shown during use of the membrane assembly to remove contaminants from a semiconductor processing fluid such as a photoresist solution, or may be shown by testing under controlled conditions such as by measuring retention of test contaminants present in a test solution that contains a known concentration of test particles, under controlled conditions. An example of test particles is G25 particles made of polystyrene and having an average particle diameter of from 3 to 25 nanometers. Other types and sizes of test particles may also be suitable for measuring retention of the assembly and of each polymeric filter membrane individually.

Example assemblies that include (comprise, consist essentially of, or consist of) a single first polymeric filter membrane and a single second polymeric filter membrane can exhibit a measured retention value that exceeds 99 percent for a monolayer coverage of 1.0 percent; a retention that exceeds 98 or 99 percent for a monolayer coverage of 2.0; a retention that exceeds 98 percent for a monolayer coverage of 3.0; and a retention that exceeds 98 percent for a monolayer coverage of 4.0; each as measured using the test described in the Examples section, with a useful flow rate through the membrane. See FIGS. 4 and 5.

A membrane assembly that includes (comprises, consists essentially of, or consists of) the first polymeric filter membrane and the second polymeric filter membrane may have a flow time that is comparable to a flow time of either or both of the first polymeric filter membrane of the assembly or the second polymeric filter membrane of the assembly when each is measured separately. The assembly can have a useful or a relatively low flow time, preferably in combination with a bubble point that is relatively high and good filtering performance, e.g., as described herein for a membrane assembly. Example membrane assemblies may have a measured flow time that is below 20,000 seconds measured using IPA as described herein.

A membrane assembly that includes at least a first (open) polymeric filter membrane and a second (tight) polymeric filter membrane may be incorporated into a filter product and used for filtering a liquid such as a semiconductor processing liquid. The assembly may include the first polymeric filter membrane and the second polymeric filter membrane arranged in series between an inlet and an outlet of a filter product. The assembly may include or may be used in cooperation with one or more additional membranes or support layers or supporting structures such as a frame. In preferred uses, the first polymeric filter membrane is upstream relative to a flow of liquid through the assembly and the second polymeric filter membrane is downstream. An upstream side of the second polymeric filter membrane faces a downstream side of the first polymeric filter membrane. A liquid flows first through the first polymeric filter membrane and then through the second polymeric filter membrane.

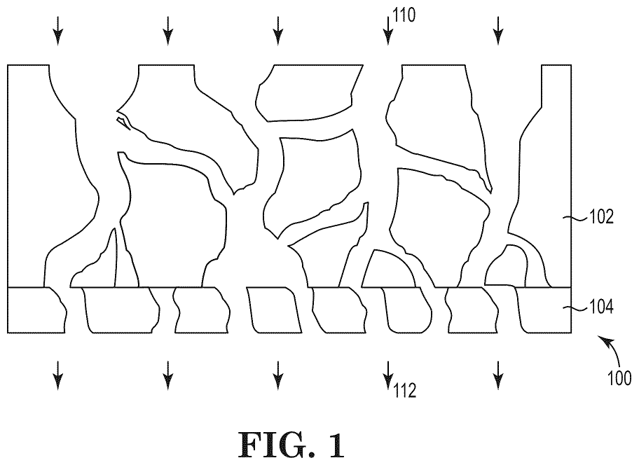

Referring to FIG. 1, illustrated is an assembly 100 of a first (open) polymeric filter membrane 102 and a second (tight) polymeric filter membrane 104, in series. Open polymeric filter membrane 102 is upstream relative to a flow of liquid 110 into the upstream surface of open polymeric filter membrane 102. Liquid 110 (see arrows) flows into first polymeric filter membrane 102, which has a greater thickness and larger pore sizes compared to second polymeric filter membrane 104. Contaminants that are present in liquid 110 are removed by the pores of first (open) polymeric filter membrane 102. After flowing through polymeric membrane 102 the liquid flows into second (tight) polymeric filter membrane 104, having a smaller thickness and relatively smaller sized pores. Smaller contaminants that remain in the liquid 110 after liquid 110 has passed through first polymeric filter membrane 102 can be removed by second polymeric filter membrane 104 either by a sieving or a non-sieving mechanism. Filtrate 112 (see arrows) passes from the downstream surface of second polymeric filter membrane 104.

Assembly 100 of FIG. 1 is shown to consist of the first polymeric filter membrane 102 and the second polymeric filter membrane 104, with no additional filter membranes or support membranes or structures, which while not illustrated may be included during use of example assembly 100. Also, second polymeric filter membrane 104 is illustrated as consisting of a single polymeric filter membrane layer but may optionally be made to include two or more sublayers as described herein.

Polymeric filter membranes 102 and 104 may be separate from each other, i.e., not attached, but arranged with the downstream surface of first polymeric filter membrane 102 facing or being adjacent to or in contact with the upstream surface of second polymeric filter membrane 104. If desired but not as a requirement, the two polymeric filter membranes may be attached at their opposed surfaces (the outlet surface of the first polymeric filter membrane being attached to the inlet surface of the second polymeric filter membrane) by a lamination step by which the surfaces of the two polymeric filter membranes are brought into contact with each other and with elevated temperature and slight pressure are caused to adhere together. The temperature and pressure conditions of an optional lamination step are moderate to avoid significantly affecting the morphology and filtering performance properties (flow time, retention) of the first polymeric filter membrane or the second polymeric filter membrane. The lamination step can be performed without placing an additional material such as an adhesive between the surfaces of the two polymeric filter membranes.

The membrane assembly can be incorporated into a filter product such as a filter cartridge (a removable filter cartridge) that supports the membrane assembly within a flow of a liquid, or a filter housing which includes any structure that supports the membrane assembly to allow a liquid fluid to flow through the membrane assembly from an inlet side of the membrane assembly, through the membrane assembly, to exit an outlet side of the membrane assembly. A filter housing may include an inlet on one side of the supported membrane assembly that allows fluid to enter the filter housing when the membrane assembly is supported by the housing, and an outlet on a second side of the membrane assembly that allows the fluid after passing through the membrane assembly to exit the filter housing.

The terms “inlet” and “outlet” may refer to specific structures such as defined openings or a defined conduits (a tube, a pipe, or an engagement thereof) of a filter housing or a component of a filter housing (e.g., a supportive frame, a core, a cage, or the like), or may refer to a space (an “inlet space” or an “outlet space”) located on either side of the membrane assembly when supported by the filter housing that accommodates flow of fluid into or out of the membrane assembly. The terms “inlet” and “outlet” may refer generally to spaces on either side of the membrane assembly that accommodate the flow of fluid into the membrane assembly, through the membrane assembly, and from the membrane assembly when the membrane assembly is supported by the filter housing.

The filter housing includes the membrane assembly supported to allow fluid to pass through the membrane and may be a component of a larger filtering system that supplies filtered liquid chemical to a tool or process for manufacturing microelectronic or semiconductor devices. The filter assembly or the filter housing may include one or more of various additional materials and structures that support the membrane assembly within a filter housing to facilitate the flow of fluid through the membrane assembly. The membrane assembly supported by the filter housing can be in any useful shape, e.g., a pleated cylinder, cylindrical pads, one or more non-pleated (flat) cylindrical sheets, a pleated sheet, among others.

One example of a filter structure (e.g., a removable filter cartridge) that includes a membrane assembly may be in the form of a replaceable filter cartridge that includes a pleated cylindrical filter element that includes the membrane assembly with additional components that may include one or more of: a rigid or semi-rigid core that supports a pleated membrane assembly at an interior side (inlet or outlet) of the pleated membrane assembly; a rigid or semi-rigid cage that supports or surrounds an exterior side (outlet or inlet) of the pleated membrane assembly at an exterior of the membrane assembly; and optional end pieces or “pucks” that are situated at each of the two opposed ends of the pleated membrane assembly. A replaceable filter cartridge is considered to have an inlet on one side of the membrane assembly and an outlet on an opposite side of the membrane assembly; an inlet or an outlet may be on either side of the membrane depending on the direction of flow of liquid through the membrane assembly.

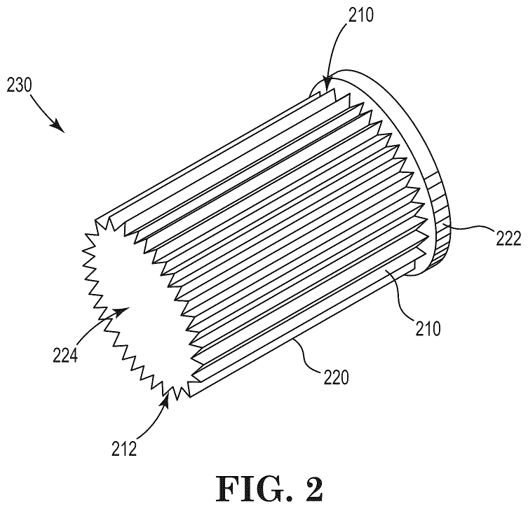

As one example, FIG. 2 shows filter product (replaceable filter cartridge) 230, which comprises pleated cylindrical component (e.g., filter element) 210 and end piece 222, with other optional structural components not specifically shown. Cylindrical component 210 includes a membrane assembly 212 as described herein, and is pleated. End piece 222 is attached (e.g., “potted”) to one end of cylindrical filter component 210. End piece 222 can preferably be made of a melt-processable polymeric material such as a thermoplastic fluoropolymer. A core (not shown) can be placed at the interior opening or space (“inlet”) 224 of pleated cylindrical component 210, and a cage (not shown) can be placed about the exterior opening or space (“outlet”) of pleated cylindrical component 210. Accordingly, the cartridge includes an inlet and an outlet (e.g., at a core, cage, or other supporting structure) on each of the inlet (upstream) side of the membrane and the outlet (downstream) side of membrane assembly 212, with the location of the inlet and the outlet depending on the direction in which a liquid is caused to flow through the membrane assembly 212 while cartridge 230 is installed within a filter housing, which can also have an inlet and an outlet. A second end piece (not shown) can be attached (“potted”) to the second end of pleated cylindrical component 230. The resultant replaceable filter cartridge 230 with two opposed potted ends and optional core and cage can then be placed into a larger filter housing that includes an upstream housing inlet to receive liquid to flow into the filter membrane, and a downstream housing outlet to discharge liquid that has passed through the membrane assembly. The housing is configured to cause an amount of liquid that enters the housing at the housing inlet to necessarily pass through membrane assembly 212 before exiting the filter housing at the housing outlet.

Components of a filter housing can be of any useful and desired size, shape, and materials, and can preferably be a fluorinated or non-fluorinated polymer such as nylon, polyethylene, or fluorinated polymer such as a poly(tetrafluoroethylene-co-perfluoro (alkyvinylether)), TEFLON® perfluoroalkoxyalkane (PFA), perfluoromethylalkoxy (MFA), or another suitable fluoropolymer (e.g., perfluoropolymer).

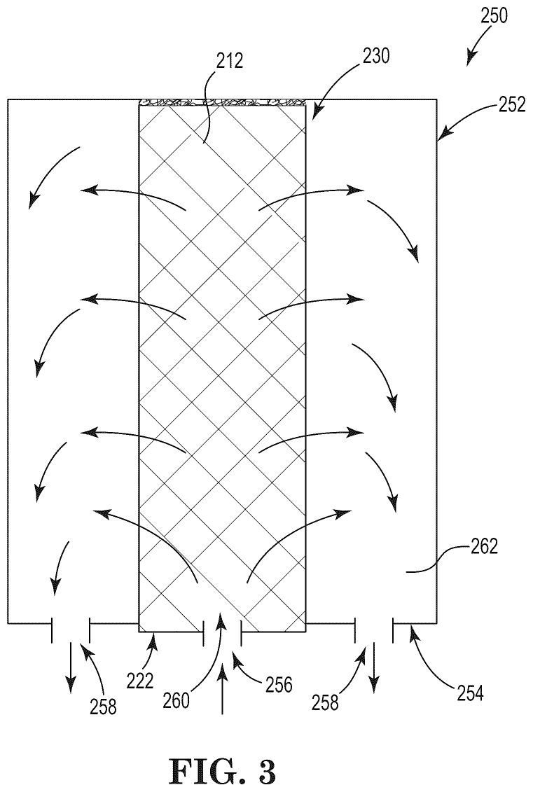

Referring to FIG. 3, filter product 250 includes a housing that contains replaceable filter cartridge 230, within an interior. Filter product 250 includes a two-component housing that includes bowl 252 attached to base 254 at an open end of bowl 252. Optionally, bowl may be removably engaged with base 254 to allow bowl 252 to be separated from base 254 to allow a removable filter cartridge 230 to be placed into or removed from the interior of the housing. The assembled housing includes inlet 256, inlet space 260 at an interior side of cartridge 230, outlet space 262 between cartridge 230 and bowl 252, and outlet 258. Removable filter cartridge 230 can be located at an interior of bowl 252 in an arrangement to allow liquid to flow into inlet 256, into inlet space 260, then through filter assembly 212 of cartridge 230, into outlet space 262, then to be discharged from filter product 250 through outlet 258.

A membrane assembly as described can be useful in a method of filtering a liquid chemical to purify or remove unwanted materials (contaminants) from the liquid chemical, especially to produce a highly pure liquid chemical that is useful for an industrial process that requires a liquid chemical input that has a very high level of purity. Generally, the liquid chemical may be any of various useful commercial liquid chemicals of a type that is useful in any industrial or commercial application. Particular examples of membrane assemblies and filter products as described can be used for purifying a liquid chemical that is used in a semiconductor or microelectronic fabrication application, e.g., for filtering a liquid solvent or other process solution used in a method of semiconductor photolithography, a wet etching or cleaning step, a method of forming spin-on-glass (SOG), for a backside anti-reflective coating (BARC) method, etc.

Some specific, non-limiting, examples of solvents (including cleaning solutions) that can be filtered using a membrane assembly as described include: n-butyl acetate (nBA), isopropyl alcohol (IPA), 2-ethoxyethyl acetate (2EEA), a xylene, cyclohexanone, ethyl lactate, methyl isobutyl carbinol (MIBC), methyl isobutyl ketone (MIBK), isoamyl acetate, undecane, propylene glycol methyl ether (PGME), propylene glycol monomethyl ether acetate (PGMEA), or a mixture of any of these, such as mixture of PGME and PGMEA; or concentrated or dilute ammonium hydroxide, hydrogen peroxide, hydrochloric acid, HF, sulfuric acid, another peroxide solution, or combinations of these such as a combination of ammonium hydroxide and hydrogen peroxide, or a combination of hydrochloric acid and hydrogen peroxide.

A more specific example of a semiconductor processing fluid is a “photoresist solution” that includes a polymeric resin, sensitizer (also known as an “inhibitor,” and regulates the photochemical process), and solvent.

Example photoresist solutions include a reactive, curable polymeric resin that can be cured in the presence of electromagnetic radiation in the presence of a sensitizer. The type of radiation may be: deep-ultraviolet radiation, near-ultraviolet radiation, e-beam radiation, x-ray radiation. Examples of specific reactive polymers that are known to be useful in photoresist solutions include polymethacrylate (PMMA) resins, isoprene, polyalkylaldehyde, diazonaphthoquinone (DNQ) resins, novolac resins (phenol-formaldehyde polymer), epoxy-based resins, off-stoichiometry thiol-enes (OSTE) polymer resins, and hydrogen silsequioxane (HSQ) resins. Various solvents and photosensitizers are known to be useful in photoresist solutions that contain the different types of curable polymeric resins. Each of the polymeric resin, solvent, and sensitizer may be used in a specific amount that will be effective to perform in a particular photoresist solution.

Examples of unwanted contaminants that may be present in a photoresist solution and may desirable be removed by a filtration step using a membrane assembly as described include particulate contaminants that may be particles of reactive polymer, dissolved metal ions (“metals”), or other particulate or dissolved contaminants.

The terms “metal” and “metal ion” are used in a manner that is consistent with the use of these terms in the chemical and semiconductor processing arts and refer to molecular species that include a metal ion, metal atom, or a metal complex. A metal contaminant may be or may include a neutral, negatively charged, or positively charged metal species. Some examples of specific metals or metal ions that may removed from a photoresist solution include Na, K, Ca, Fe, Mg, Al, Cr, Ni, and Zn.

Particulate contaminants in a photoresist solution may include reactive monomeric, oligomeric, or polymeric polymer having particle sizes in a range from 0.01 to 0.2 microns.

A membrane assembly or a first membrane or a second membrane may be tested individually or together for retention, bubble point, and flow time according to the following test methods.

### Retention Test Method Using Test Particles

A level of effectiveness of a polymeric filter membrane or membrane assembly in removing unwanted material (i.e., “contaminants”) from a liquid can be measured, in one fashion, as “retention.” Retention generally refers to an amount of a contaminant that is removed from a liquid that contains the contaminant relative to a total amount of the contaminant that is initially present in the liquid before passing the liquid through the membrane or membrane assembly. The “retention” value of a polymeric filter membrane or membrane assembly is a percentage, with a polymeric filter membrane that has a higher retention value (a higher percentage) being relatively more effective in removing a contaminant from a liquid, and a polymeric filter membrane that has a lower retention value (a lower percentage) being relatively less effective in removing a contaminant from a liquid.

Retention can be measured by measuring a number of test particles removed from a flow of liquid by a polymeric filter membrane or membrane assembly that is placed in the flow of liquid. By one method, retention can be measured by passing a sufficient amount of an aqueous test solution through a membrane that contains 0.1% Triton X-100 and 8 ppb polystyrene particles (e.g., G25 round polystyrene particles having a nominal diameter in from 3 to 25 nanometers) to achieve 1% monolayer coverage of the membrane, at a constant flow, and collecting the permeate. The concentration of the polystyrene particles in the permeate can be calculated from the absorbance of the permeate. Particle retention is then calculated using the following equation based on particle concentrations in the feed and the filtrate:

$$Particle retention = 1 - ( \frac{average of sample data - a v erage of blank}{a v erage of feed - a v erage of blank} ) * 100 \%$$

### Bubble Point Test Method Using HFE-7200

By one method of determining a bubble point of a polymeric filter membrane, a sample of the polymeric filter membrane is immersed in and wetted with a liquid having a known surface tension and a gas pressure is applied to one side of the sample. The gas pressure is gradually increased. To measure a bubble point, a 47 mm polymeric filter membrane disc is placed in a holder and a highly permeable spunbonded nonwoven (PGI Inc.) is placed on the downstream as a support layer. Air is pressurized through the holder and measured as a function of pressure. A low surface tension fluid, HFE-7200 (3M) is then introduced to the downstream side to wet the membrane. Air is pressurized through the holder again and the air flow is measured as a function of pressure.

The minimum pressure at which the gas flows through the sample is called an initial bubble point.

The pressure at which the ratio of the air flow of the wet membrane to the air flow of the dry membrane is 0.5 is referred to as the mean bubble point. If a membrane produces two different pressure values based on which side of the membrane faces the air, the lower measured value is used as the mean bubble point.

### Flow Time Test Method

The ease of a liquid to pass through a polymeric filter membrane or membrane assembly, e.g., a flow rate of a liquid through a membrane or a membrane assembly, can be assessed as a measured “flow time,” which is an inverse of the flow rate. Flow time may be defined as the time required to pass 500 milliliters of fluid (in this case isopropyl alcohol) through a porous membrane or membrane assembly having a surface area of 13.8 cm² at 14.2 psi.

### EXAMPLES

Table 1 shows a comparison of mean bubble point, flow time, and thickness of two examples of first (open) polymeric filter membranes, a single example of a second (tight) polymeric filter membrane, and an example of an assembly that includes both a first (open) polymeric filter membrane and a second (tight) polymeric filter membrane.

TABLE 1

| | Assembly 1 | | | Assembly 2 | | | Example |
|---|---|---|---|---|---|---|---|
| | | | Composite | | | Composite | Tight |
| | 1^{st} layer | 2^{nd} layer | Membrane | 1^{st} layer | 2^{nd} layer | Membrane | Membrane 2 |
| Thickness | 222 | 5 | 227 | 219 | 5 | 224 | 5 |
| (microns) | | | | | | | |
| Mean bubble | 122 | 174 | 174 | 106 | 174 | 174 | 174 |
| point (psi) | | | | | | | |
| Flow time (s) | 7829 | 7084 | 14913 | 5968 | 7084 | 13052 | 7084 |

TABLE 2

| | Assembly 2 | | | Example | Example |
|---|---|---|---|---|---|
| | 1^{st} | 2^{nd} | Composite | Open | Open |
| | layer | layer | Membrane | Membrane 3 | Membrane 4 |
| Thickness | 219 | 5 | 224 | 219 | 173 |
| (microns) | | | | | |
| Mean bubble | 106 | 174 | 174 | 131 | 125 |
| point (psi) | | | | | |
| Flow time (s) | 5968 | 7084 | 13052 | 10212 | 13643 |

The graphs at FIGS. 4 and 5 shows particle retention data of membranes and membrane assemblies of Tables 1 and 2, tested using of G25 PSL test particles contained at 8 parts per million in deionized water and 0.1 percent of Triton X-100 surfactant, per the retention test method described herein.

FIG. 4 shows measured retention values of two different assemblies (“Assembly 1” and “Assembly 2”) of a first (open) polymeric filter membrane and a second (tight) polymeric membrane. Assembly 1 is a non-laminated assembly consisting of an open polymeric filter membrane (“first layer”) and a tight polymeric filter membrane (“second layer) made of stretched UPE. Assembly 2 is a non-laminated assembly consisting of an open polymeric filter membrane (“first layer”) and a tight polymeric filter membrane (“second layer”) made of stretched UPE. The measured retention of each of Assembly 1 and Assembly 2 is at least 98 percent for the test particles at particle loadings that correlate to monolayers of 1.0, 2.0, 3.0, and 4.0.

FIG. 4 also shows measured retention values of a tight polymeric filter membrane (“Example Tight Membrane 2”), which is a stretched UPE membrane, tested alone. The measured retention of Example Tight Membrane 2 is approximately 98 percent for the test particles at particle loadings that correlate to a monolayer of up to 1.5, and is below 98 percent for higher particle loadings.

FIG. 5 shows measured retention values of Assembly 2 and compares those values to measured retention values of two different open polymeric filter membranes (“Example Open Membrane 3” and “Example Open Membrane 4”). Example Open Membrane 3 is a melt cast membrane. Example Open Membrane 4 is a melt cast membrane.

The measured retention of Assembly 2 is at least 98 percent for the test particles at particle loadings that correlate to monolayers of 1.0, 2.0, 3.0, and 4.0.

The measured retention of Example Open Membrane 3 is approximately 98 percent for the test particles at particle loadings that correlate to a monolayer of up to 1.5 or about 2.0 and is below 98 percent for higher particle loadings.

The measured retention of Example Open Membrane 4 is approximately 98 percent for the test particles at particle loadings that correlate to a monolayer of up to about 2.5 and is below 98 percent for higher particle loadings.

### EXEMPLARY ENUMERATED EMBODIMENTS

The following numbered embodiments, while non-limiting, are exemplary of certain aspects of the present disclosure:

1. A method of filtering a semiconductor processing liquid, the method comprising:
passing the liquid through a first polymeric filter membrane having:
   a mean bubble point below 120 pounds per square inch measured using ethoxy-nonafluorobutane (HFE7200), and
   a thickness of at least 20 microns; and
passing the liquid through a second polymeric filter membrane having:
   a mean bubble point greater than 120 pounds per square inch measured using ethoxy-nonafluorobutane (HFE7200), and
   a thickness less than 20 microns.
      2. The method of embodiment 1, wherein the method of passing the liquid through both the first polymeric filter membrane and the second polymeric filter membrane removes a higher amount of contaminants from the liquid compared to both: a method of passing the liquid through the first polymeric filter membrane alone, and a method of passing the liquid through the second polymeric filter membrane alone.
      3. The method of embodiment 1, wherein the liquid is a photoresist solution that comprises: polymeric resin, sensitizer, and solvent.
      4. The method of embodiment 3, wherein the photoresist solution comprises metal contaminants.
      5. The method of embodiment 3, wherein the photoresist solution comprises contaminant particles having particle sizes in a range from 0.01 to 0.2 microns.
      6. The method of embodiment 1, wherein the first polymeric filter membrane is a melt cast polyolefin membrane.
      7. The method embodiment 1, wherein the first polymeric filter membrane has a thickness in a range from 20 to 300 microns.
      8. The method of embodiment 1, wherein the second polymeric filter membrane is a stretched polyolefin membrane.
      9. The method of embodiment 1, wherein the second polymeric filter membrane has a thickness in a range from 0.1 to 10 microns.
      10. A filter product useful to remove a contaminant from a semiconductor processing fluid, the filter product comprising:
a first polymeric filter membrane having
   a mean bubble point below 120 pounds per square inch measured using ethoxy-nonafluorobutane (HFE7200), and
   a thickness of at least 20 microns; and
a second polymeric filter membrane having
   a mean bubble point greater than 120 pounds per square inch measured using ethoxy-nonafluorobutane (HFE7200), and
   a thickness less than 20 microns.
      11. A filter product of embodiment 10, wherein the first polymeric filter membrane is a melt cast polyolefin membrane.
      12. The filter product of embodiment 10, wherein the first polymeric filter membrane has a thickness in a range from 20 to 300 microns.
      13. The filter product of embodiment 10, wherein the second polymeric filter membrane is a stretched polyolefin membrane.
      14. The filter product of 10, wherein the second polymeric filter membrane has a thickness in a range from 0.1 to 10 microns.
      15. The filter product of embodiment 10, comprising a frame and the first polymeric filter membrane and the second polymeric filter membrane are supported by the frame.
      16. The filter product of embodiment 10, wherein the filter product is a replaceable filter cartridge.
      17. The filter product of embodiment 10, wherein the filter product comprises a housing comprising an inlet, an inlet space, an outlet, and an outlet space, adapted to allow liquid to flow into the inlet space through the inlet, then through the first polymeric filter membrane, then through the second polymeric filter membrane, and then into the outlet space.
      18. The filter product of embodiment 10, wherein the filter product provides better retention of G25 round polystyrene particles compared to both: retention of the first polymeric filter membrane alone, and retention of the second polymeric filter membrane alone.
      19. The filter product of embodiment 10, wherein the filter product exhibits a measured retention of at least 98 percent based on a 4.0 percent monolayer using G25 round polystyrene particles having a nominal diameter of 5 to 15 nanometers.
      20. The filter product of embodiment 10, wherein the filter product exhibits a measured retention of at least 98 percent based on a 3.0 percent monolayer using G25 round polystyrene particles having a nominal diameter of 5 to 15 nanometers.
      21. A semiconductor processing filtration system comprising:
the filter product of embodiment 17,
a source of semiconductor processing fluid connected to the inlet, and
a semiconductor processing apparatus connected to the outlet.
   22. The semiconductor processing filtration system of embodiment 21, wherein the semiconductor processing fluid is a photoresist solution.

1. A method of filtering a semiconductor processing liquid, the method comprising:
passing the liquid through a first polymeric filter membrane having:
a mean bubble point below 120 pounds per square inch measured using ethoxy-nonafluorobutane (HFE7200), and
a thickness of at least 20 microns; and
passing the liquid through a second polymeric filter membrane having:
a mean bubble point greater than 120 pounds per square inch measured using ethoxy-nonafluorobutane (HFE7200), and
a thickness less than 20 microns.

2. The method of claim 1, wherein the method of passing the liquid through both the first polymeric filter membrane and the second polymeric filter membrane removes a higher amount of contaminants from the liquid compared to both: a method of passing the liquid through the first polymeric filter membrane alone, and a method of passing the liquid through the second polymeric filter membrane alone.

3. The method of claim 1, wherein the liquid is a photoresist solution that comprises:
polymeric resin, sensitizer, and solvent.

4. The method of claim 3, wherein the photoresist solution comprises metal contaminants.

5. The method of claim 3, wherein the photoresist solution comprises contaminant particles having particle sizes in a range from 0.01 to 0.2 microns.

6. The method of claim 1, wherein the first polymeric filter membrane is a melt cast polyolefin membrane.

7. The method claim 1, wherein the first polymeric filter membrane has a thickness in a range from 20 to 300 microns.

8. The method of claim 1, wherein the second polymeric filter membrane is a stretched polyolefin membrane.

9. The method of claim 1, wherein the second polymeric filter membrane has a thickness in a range from 0.1 to 10 microns.

10. A filter product useful to remove a contaminant from a semiconductor processing fluid, the filter product comprising:
a first polymeric filter membrane having
a mean bubble point below 120 pounds per square inch measured using ethoxy-nonafluorobutane (HFE7200), and
a thickness of at least 20 microns; and
a second polymeric filter membrane having
a mean bubble point greater than 120 pounds per square inch measured using ethoxy-nonafluorobutane (HFE7200), and
a thickness less than 20 microns.

11. A filter product of claim 10, wherein the first polymeric filter membrane is a melt cast polyolefin membrane.

12. The filter product of claim 10, wherein the first polymeric filter membrane has a thickness in a range from 20 to 300 microns.

13. The filter product of claim 10, wherein the second polymeric filter membrane is a stretched polyolefin membrane.

14. The filter product of 10, wherein the second polymeric filter membrane has a thickness in a range from 0.1 to 10 microns.

15. The filter product of claim 10, comprising a frame and the first polymeric filter membrane and the second polymeric filter membrane are supported by the frame.

16. The filter product of claim 10, wherein the filter product is a replaceable filter cartridge.

17. The filter product of claim 10, wherein the filter product comprises a housing comprising an inlet, an inlet space, an outlet, and an outlet space, adapted to allow liquid to flow into the inlet space through the inlet, then through the first polymeric filter membrane, then through the second polymeric filter membrane, and then into the outlet space.

18. The filter product of claim 10, wherein the filter product provides better retention of G25 round polystyrene particles compared to both: retention of the first polymeric filter membrane alone, and retention of the second polymeric filter membrane alone.

19. The filter product of claim 10, wherein the filter product exhibits a measured retention of at least 98 percent based on a 4.0 percent monolayer using G25 round polystyrene particles having a nominal diameter of 5 to 15 nanometers.

20. The filter product of claim 10, wherein the filter product exhibits a measured retention of at least 98 percent based on a 3.0 percent monolayer using G25 round polystyrene particles having a nominal diameter of 5 to 15 nanometers.
